(19) United States
(12) Patent Application Publication
(10) Pub. No.: US 2008/0070196 A1
(43) Pub. Date: Mar. 20, 2008

(54) Docked emulation system

(75) Inventors: Roger A. Luty, Houston, TX (US); David J. McDill, Webster, TX (US); Susan B. Ahrens, Friendswood, TX (US); Jonathan F. Morsics, Satellite Beach, FL (US)

Correspondence Address: GREENBERG TRAURIG, LLP, 1750 TYSONS BOULEVARD, 12TH FLOOR, MCLEAN, VA, 22102, US

(73) Assignee: United Space Alliance, LLC, Houston, TX (US)

(21) Appl. No.: 11/509,473

(22) Filed: Aug. 23, 2006

(51) Int. Cl. G09B 19/16

(52) U.S. Cl. 434/34

(57) ABSTRACT

A docked emulation system is provided which accesses real flight software and emulates the hardware interaction between an outpost system and a second system docking thereto. The system includes a MIL-STD-1553B software application that accesses data on an emulated MIL-STD-1553B bus to drive external MIL-STD-1553B applications in the second docking system. The system further includes software portal applications that access data traffic on emulated data buses to interface a data exchange between the outpost flight software and simulation models for outpost craft avionics and other components. A telemetry server in the system provides raw data from the flight software into a format complying with control center applications. The docked emulation system allows analysis of an emulated docking interaction between two outpost systems from a PC workstation without requiring access to actual flight computers of either system.

The U.S. Government has certain license rights with respect to the invention claimed herein pursuant to the terms of Contract No. NAS9-20000 between United Space Alliance, LLC and the National Aeronautics & Space Administration (“NASA”).

### BACKGROUND

This disclosure relates generally to the field of simulator systems and, more particularly, to the field of spacecraft simulator systems for simulating the hardware interaction between docked outpost spacecraft.

Flight controllers and astronauts are responsible for operating and maintaining spacecraft and space systems, such as the International Space Station (ISS). An extensive familiarity and understanding of the flight software is essential for such systems prior to their launching, because the tremendous costs and remote locations of the launched systems prevent the aerospace industry from discovering errors in the field in a trial and error process. Procedures are developed to document the exact order of commands and operations needed to execute tasks and handle emergencies, where these procedures involve commanding and receiving responses from the flight software. These procedures are developed, tested, and verified by flight controllers before deployment. It is imperative for flight controllers and training crew to comprehensively test spacecraft and their related operating software using these procedures in order to evaluate the entire system against all of the operational requirements in order to discover all possible situations that may be encountered in space. Only after the procedures have been verified using the flight software are they deployed into the spacecraft for operational use.

Flight controllers build knowledge of the flight software through operational experience in actual console time at integrated and specialized training facilities. These facilities are used to either analyze the functionality of the flight software or to train flight controllers on the operation of the flight software. These facilities typically constrain the test case to a sequentially controlled procedure, where the flight controller is not free vary from this controlled procedure to explore the boundaries of the flight software to determine all of its capabilities. As a result, the flight controller is typically unable to build additional knowledge to support procedure development. Further, the flight controller is unable to unit test the procedures that are developed prior to the verification test that is run in one of the major simulation facilities. If a problem occurs during the verification test, the procedure must be fixed and a new test run scheduled, leading to an increase in time and cost in fine tuning the procedures.

There is a need to develop a system that provides access to flight software to emulate commanding and monitoring applications from a workstation in an easily accessible environment. There is further a need to develop a system that is capable of accessing the flight software without being bound to sequentially controlled procedures in order to allow a flight controller to train on or access selected portions of the flight software.

### SUMMARY

According to a feature of the disclosure, a docked emulation system is provided which emulates the commanding and monitoring of an outpost system by accessing real flight software while simulating the hardware interaction between the outpost system and a second system docked thereto. The system includes a MIL-STD-1553B software application that accesses data on an emulated MIL-STD-1553B bus to drive external MIL-STD-1553B applications in the second docked system. The system further includes software portal applications that access data traffic on emulated data buses to interface a data exchange between the outpost flight software and simulation models for outpost craft avionics and other components. The docked emulation system may include a telemetry server for providing raw data obtained from the flight software into a format complying with control center applications. The docked emulation system allows analysis of an emulated interaction between two docked outpost systems from a PC workstation without requiring access to actual flight computers of either system being emulated.

For purposes of summarizing the disclosure and the advantages achieved over the prior art, certain advantages of the disclosure have been described herein. Of course, it is to be understood that not necessarily all such advantages may be achieved in accordance with any particular embodiment of the disclosure. Thus, for example, those skilled in the art will recognize that the disclosure may be embodied or carried out in a manner that achieves or optimizes one advantage or group of advantages as taught herein without necessarily achieving other advantages as may be taught or suggested herein.

All of these embodiments are intended to be within the scope of the disclosure herein disclosed. These and other embodiments of the present disclosure will become readily apparent to those skilled in the art from the following detailed description of the preferred embodiments having reference to the attached figures, the disclosure not being limited to any particular preferred embodiment disclosed.

### DRAWINGS

The above-mentioned features and objects of the present disclosure will become more apparent with reference to the following description taken in conjunction with the accompanying drawings wherein like reference numerals denote like elements and in which:

FIG. 1 is a block schematic diagram of a docked emulation system in accordance with the present disclosure.

FIG. 2 is a block schematic diagram of a docked emulation system in accordance with the present disclosure.

FIG. 3 is a block schematic diagram of the architecture of a docked emulation system in accordance with the present disclosure.

### DETAILED DESCRIPTION

The present disclosure provides a docked emulation system to emulate the commanding and monitoring of an outpost system by accessing actual flight software and simulating the interaction between the outpost system and a second system docking thereto. The docked emulation system is capable of emulating the hardware interaction between two outpost systems in a desktop personal computer environment, such as Microsoft Windows®, or other similar workstation. The outpost system being emulated may comprise any type of space craft or avionics system, such as but not limited to the International Space Station (ISS) or Space Shuttle. The second docked system may comprise any other type of spacecraft or avionics component, such as a visiting vehicle, that may dock or otherwise connect to the outpost system.

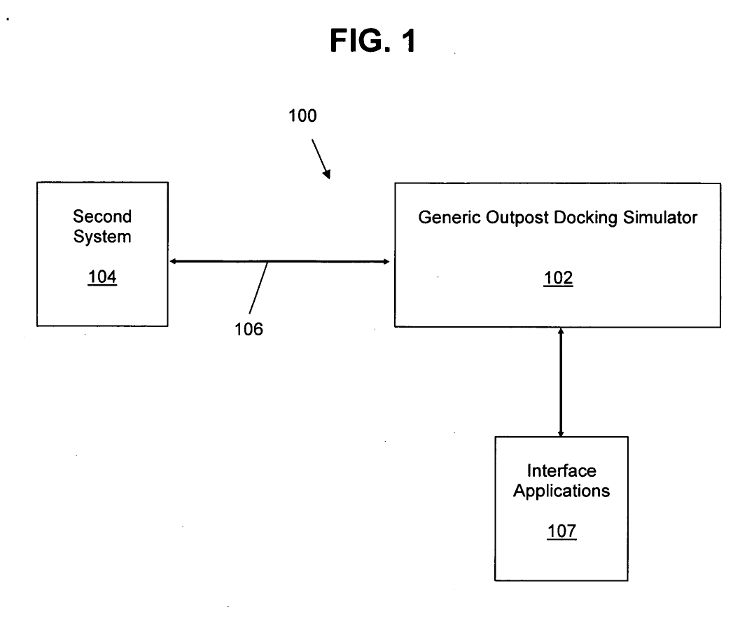

In one aspect, as illustrated in the block schematic shown in FIG. 1, the docked emulation system 100 includes a generic outpost docked simulator 102 capable of emulating communication with a second system 104 communicate through a communication link 106. An interface application 107 provides a user with operational access to the docked simulator 102, where the interface application 107 may be located with the docked simulator 102 or may be remotely connected to the docked simulator 102 through a communication link. In one aspect, the docked emulation system 100 may include a telemetry server through which at least one and possibly a plurality of interface applications 107 may communicate with the outpost docked simulator 102.

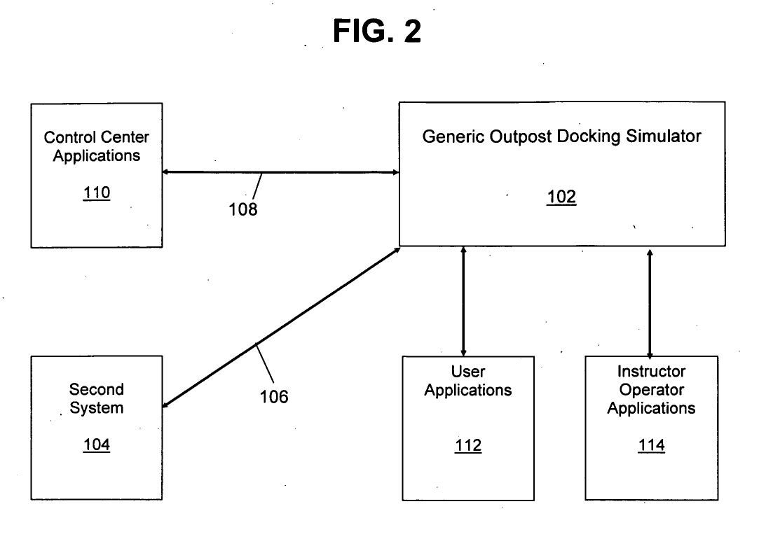

It is understood that any number of interface applications may be connected to the docked simulator 102. In one aspect, as illustrated in FIG. 2, the outpost docked simulator 102 is communicatively connected to user applications 112 and instructor operation applications 114, where the user applications 112 allow a user to run the simulator operations of the docked simulator 102 while the instructor operation applications 114 allow an instructor to oversee and control the simulation. The outpost docked simulator 102 may further be communicatively coupled through communication link 108 to flight control center applications 110, such as those applications commonly run through a control center.

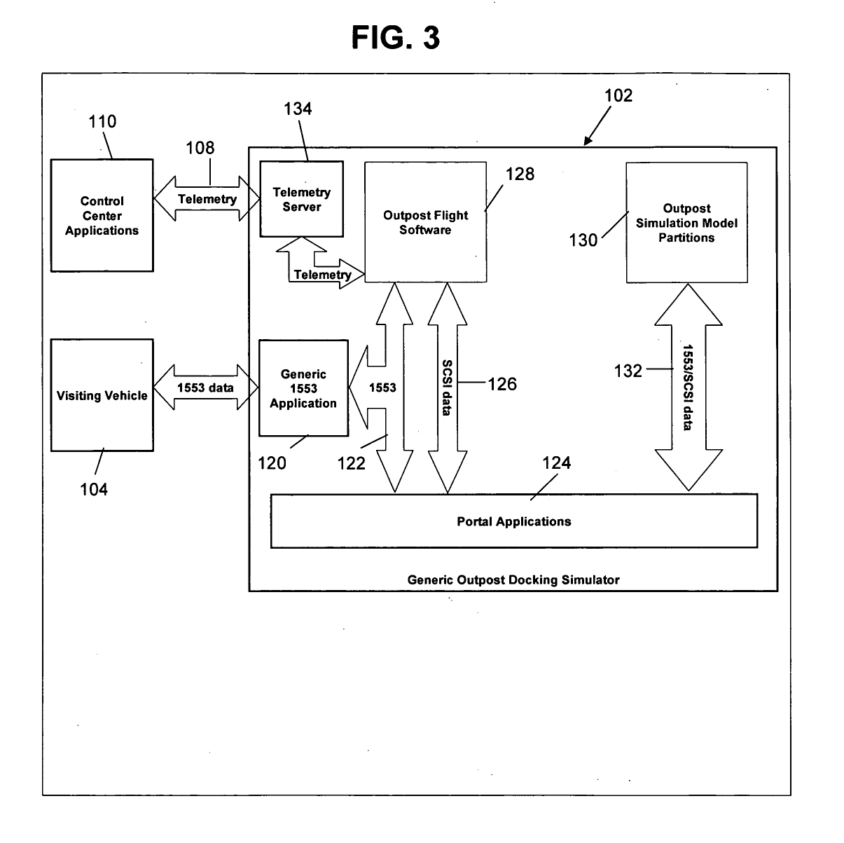

Referring now to the block schematic architectural illustration of the outpost docked simulator 102 shown in FIG. 3, the outpost docked simulator 102 in one aspect includes a multitude of components, software applications and subsystems, including at least a: (1) generic MIL-STD-1553 application 120, (2) an emulated 1553 bus 122, (3) portal applications 124, (4) outpost flight software 128 and (5) outpost simulation models 130. MIL-STD-1553 (“1553”) is a U.S. Department of Defense military standard which defines the mechanical, electrical and functional characteristics of a serial data bus for use with avionics and spacecraft. The 1553 application 120 provides a 1553 bus interface that accesses an emulated MIL-STD-1553B bus architecture 122. The 1553 application 120 may be incorporated entirely in software or a combination of software and hardware components. An emulated 1553 bus preferably uses TCP/IP sockets. The 1553 application 120 accesses MIL-STD-1553B traffic on the 1553 bus 122 to drive or otherwise interact with external applications operating according to MIL-STD-1553 on the second system 104, such that data is provided to and received from the communication link 106 in 1553 format. The communication link 106 may comprise either: 1) an emulated 1553 bus, similar to emulated 1553 bus 122, that may exist across an internet-compatible distributed computing environment, such as Ethernet or other types of networks or 2) a physical 1553 bus that utilizes a PCI-based MIL-STD-1553B card or similar device, as are well known to those skilled in the art. The 1553 application 120 and 1553 bus 122 further provide connectivity to simulations contained in the outpost simulation models 130. The outpost simulation models 130 include at least one simulation model and may include a plurality of simulation models for the outpost flight software 128.

The outpost docked simulator 102 includes portal applications 124 that provide connectivity between the outpost flight software 128 and the outpost simulation models 130. The portal applications 124 communicate with the outpost flight software 128 through the 1553 bus 122 and/or any other number of other types of buses as may be required for other types of buses. For instance, a SCSI data bus 126 may be provided for communicated SCSI data corresponding to analog and discrete sensor data for the flight software 128. The 1553 bus 122 further provides connectivity between the portal applications 124 and the 1553 application 120. The portal applications 124 allow for the simple configuration of all outpost flight software 128 and outpost simulation model data buses 132 by configuring the format of the data to be delivered to either the outpost flight software 128 and outpost simulation models 130. As such, the portal applications 124 gather data from the outpost flight software 128 as received over bus 122 or SCSI data bus 126 and translate such data to a generic data structure for transmission to the outpost simulation models 130. The portal applications 124 will conversely gather data from the outpost simulation models 130 as received over the outpost simulation model data buses 132 and translate such data to a generic data structure for transmission to the outpost fight software 128. It is understood that both the outpost flight software 128 and outpost simulation models can be designed to run in any type of computing environment, such that the portal applications can be universally configured to translate data between any two types of operating systems.

As such, the docked simulator 102 provides the unique ability of applying simulation models 130 running in one type of computing environment to flight software 128 running in another type of computer environment, so that a user of the docked simulator 102 is not limited to either the operations or locations of either the flight software 128 or simulation models 130. In one embodiment, although depicted in FIG. 3 as being located within the outpost docking simulator 102, the docking simulator 102, the flight software 128 and the outpost simulation models 130 are actually operating on three different respective computing environments (e.g., three different servers). However, it is understood that any of these components could be located on the same computing environment and are not required to be located in different computing environments provided that interoperability between the components is possible.

In one aspect, the outpost docked simulator 102 further includes a telemetry server 134 capable of receiving raw binary data from the outpost flight software 128 through a communication link 136, such as a hard-wired or wireless telemetry link, and processing the raw data into a desired format for control center applications 110. In one embodiment, the telemetry server 134 may transmit data across communication interface or link 108 in an ISP format. The outpost flight software data can then be displayed and commanded from the control center applications 110.

The outpost docked simulator 102 provides the ability to execute outpost binary flight control software, emulate outpost command and data handling, simultaneously emulate a plurality models, output data to both a physical and virtual data bus, integrate with existing vehicle subsystem models (such as outpost simulation models 130), and provide Internet-compatible distributed computing for user interfaces.

In one aspect, the docked emulation system 100 provides the ability to run authentic, unmodified, binary data from the outpost flight software 128 and transmit data back forth in a format compatible with control center applications 110 to access immediate deployments found in flight control procedures and other control center applications 110 bundle developments. The docked emulation system 100 also can be used to aid flight crew and flight controllers in developing expertise in the outpost flight software 128 from any computer on which the outpost docking simulator is loaded and operating or from networked or remote user applications 112 and instructor operation applications 114. Prior applications required expensive simulation facilities that limited utility and accessibility. This docked emulation system 100 is able to run the outpost flight software 128, run the outpost simulation models 130, and integrate the input/output data to displays and applications on the control center applications 110 without system setup complexity and overhead. A user of the docked emulation system 100 does not need to utilize expensive simulation facilities for flight software analysis and procedure development. Further, outpost flight software 128 loads can be easily selected and loaded into the outpost docked simulator 102 for any available flight software load. The docked emulation system 100 can be incorporated into any commercial-over-the-shelf (COTS) PC to run both the outpost flight software and the simulation models to simulate procedural operations between two docked outpost systems.

In various embodiments, the docked emulation system 100 is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The docked emulation system 100 may be described in the general context of computer-executable instructions, such as program modules, being executed by a computer. Generally, program modules include routines, programs, objects, components, data structures, etc. that perform particular tasks or implement particular abstract data types. In one aspect, the docked emulation system 100 is written in high-level languages (C++, Java and Ada) to enable compilation and deployment on a variety of microprocessor platforms. The system may also be practiced in distributed computing environments where tasks are performed by remote processing devices that are linked through a communications network. In a distributed computing environment, program modules may be located in both local and remote computer storage media including memory storage devices. In one embodiment, the system 100 emulates the docking of two outpost computer systems by executing one or more computer programs. The computer programs are stored in a memory medium or storage medium or they may be provided to a processing unit through a network or I/O bus.

In one aspect, the docked emulation system 100 includes at least one central processing unit (CPU) or processor. The CPU can be coupled to a memory, ROM or computer readable media. Computer readable media can be any available media that can be accessed by the system and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the docked emulation system 100. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of any of the above should also be included within the scope of computer readable media. The computer readable media may store instructions and/or data which implement all or part of the docked emulation system 100 described herein. The software package for the docked emulation system 100 is portable to several host platforms. For mission operations applications, the emulator is designed to interact easily with new or existing docking outpost systems (e.g., visiting vehicle or space craft) for training and otherwise simulating the interaction between docking activities between two outpost systems.

From the foregoing it can be seen that the present docked emulation system provides the capability of using unmodified flight software while simulating the hardware interaction across multiple outpost computers. Further, the docked emulation system provides full fidelity simulations of sensors and effectors from systems models, while using COTS desktop computers to run flight software and simulation models, thereby eliminating the need for flight controllers and crew to be physically present at major simulation facilities.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. An outpost docked simulator for simulating hardware interaction between an outpost spacecraft computer system and a second spacecraft computer system, comprising:
a general purpose 1553 application module for interfacing with MIL-STD-1553 applications operating on the second spacecraft computer system;
an emulated MIL-STD-1553 bus providing a data pathway between the 1553 application module and flight software for the outpost spacecraft computer system; and
portal application modules for configuring and interfacing data exchanges between the flight software and simulation models for the outpost spacecraft computer system.

2. The outpost docked simulator of claim 1, further comprising a telemetry server for providing a real-time telemetry connection to external applications.

3. The outpost docked simulator of claim 2, wherein the telemetry server converts unmodified data from the flight software into a format suitable for the external applications.

4. The outpost docked simulator of claim 3, wherein the external applications are running at a remote control center.

5. The outpost docked simulator of claim 1, further comprising a user application for allowing a user to connect to the outpost docked simulator to simulate hardware interaction between the outpost spacecraft computer system and the second spacecraft computer system.

6. The outpost docked simulator of claim 1, wherein the portal applications provide an interface for the flight software and the simulations models designed to operate in different respective computing environments to communicate with each other.

7. The outpost docked simulator of claim 6, wherein the portal applications are generally configurable to serve as an interface between any two computing environments for the flight software and simulation models.
